(19) United States
(12) Patent Application Publication
(10) Pub. No.: US 2006/0178135 A1
(43) Pub. Date: Aug. 10, 2006

(54) Method and apparatus for detecting and managing unreturned calls

(75) Inventors: Yue Jun Jiang, Danville, CA (US); Ori Sasson, Orinda, CA (US)

Correspondence Address: Yue Jun Jiang;c/o Legal Department, Roamware Inc., Suite 1000, 3031 Tisch Way, San Jose, CA, 95128, US

(73) Assignee: Roamware, Inc.

(21) Appl. No.: 11/272,445

(22) Filed: Nov. 9, 2005

Related U.S. Application Data
(60) Provisional application No. 60/626,411, filed on Nov. 9, 2004.

(51) Int. Cl. H04Q 7/38

(52) U.S. Cl. 455/414.1

(57) ABSTRACT

The present invention relates to methods and apparati for receiving, storing and displaying information relating to unreturned calls at an end user telecommunications device, and providing the information in a manner that is convenient for user selection and interaction. Various manners of trapping, storing and acting upon the information are disclosed. Some of the methods and apparati provide for user interactions including (i) calling back selected unreturned calls; (ii) deleting selected unreturned calls from the display or storage; (iii) traking the status of unreturned calls including age, and whether those calls have been returned. Detailed embodiments for mobile telecommunications equipment and other modes of telecommunications modes are disclosed.

This application claims priority from the U.S. Provisional Patent Application Ser. No. 60/626,411 filed Nov. 9, 2004 and entitled, “DETECTING AND MANAGING UNRETURNED CALLS.” This patent application constitutes the conversion of that Provisional Patent Application into a non-provisional patent application.

### BACKGROUND OF THE INVENTION

1. Field of the Invention

This invention relates to methods and apparati by which a telecommunications station can display a list unreturned calls, and updated information relating to those calls and the status of their return.

Today, there are solutions to manage incoming calls. However, there is no end-user equipment available for storing, displaying, and updating information relating to unreturned calls and the status of whether or when the end-user returned them. With the decreasing costs of telecommunications, busy people receive an escalating number of calls or telecommunications requests, and face increasing difficulty answering all of them, remembering who called at what time, and ensuring that they have returned the unreturned calls that they consider important.

In the current state of the art, for example, when a mobile-terminated (“MT”) call is coming in to a mobile wireless handset, given widely available incoming call management apparati, the subscriber can manage the call to accept, to forward, to call back, to SMS, to hold on or to reject etc. Some incoming call management solutions can also manage calls to multiple devices (e.g. home, office, cell phone etc) to have a uniform control on a mobile device.

When a phone call made to a mobile subscriber is “unreturned” because the subscriber's mobile handset is off, out of coverage, busy or not answering, the unreturned call records can be received by the subscriber in the following possible ways.
1. The caller ID is recorded on the handset when the handset is not answering or busy if the caller ID is delivered to the handset
2. The caller ID is sent as a SMS alert to the handset when the handset was powered back on or regaining-coverage or the caller ID was not delivered when handset is not answering or busy (e.g. when the subscriber is outbound roaming).
3. The caller leaves a voicemail (possibly with some call back details)
4. The call is forwarded to somewhere else
5. The call is dropped due to some errors (e.g. absent subscriber, no more routing number)

Unreturned calls include any cases of calls that the intended recipients did not answer the call whether the call is forwarded or not. They differ from missed calls in that it also consider cases where call forwarding and voicemail forwarding happen. When the end-user returns these previously unreturned calls, there is no management solution today to help him track whether he has returned an unreturned call or not and whether he intends to return an unreturned call or not.

There is a need in the art for a simple-to-use solution that will store a list of unreturned calls for later action and updating by the end-user.

This patent application will introduce an innovative solution to solve these problems. Providing such a solution will give an operator a competitive edge and increase its voice call back revenue and subscription revenue. Using such a solution will give a subscriber the ability to manage call returns to unreturned calls.

### SUMMARY OF THE INVENTION

Although the technical approaches described follow GSM protocols, similar approaches can be applied to ANSI-41 (CDMA, TDMA), VoIP, 3G, or any other computer-managed telecommunications protocol.

For convenience, this invention will be described and taught largely in the context of GSM technology, the patent also applies to other radio technology such as CDMA/TDMA where WIN can be applied in place of Camel, IS41 will be applied in place of GSM MAP similarly. Moreover, this invention is useful in conjunction with any end-user apparatus for initiating or receiving telecommunications sessions, including without limitation, fixed line POTS phones, internet instant messaging, voice over IP using any sort of apparatus, gaming devices for remote multi-player gaming, two-way radios and walkie talkies, two-way pager devices, satellite telephones, LAN clients, WAN clients, WLAN clients, or any Wifi or Wimax device.

Among other innovations, disclosed herein are:
1. The general idea of managing call returns to unreturned calls including those that left a voicemail, those that did not leave a voicemail and those that only resulted missed or unreturned call alerts later on after powered back on, regaining coverage, no CLI when not answering or busy
2. The general client server architecture where the network server will provide information on unreturned calls that the end-user device might not possess in its ordinary operation, and the device client will manage unreturned call alerts, or track returned calls to unreturned calls
3. The in signaling path mechanism and monitoring-based approach in capturing caller ID of an unreturned call. Note here that unreturned calls even include those that left a voicemail.
4. The dynamic FTN manipulation algorithm for outbound roaming registration to modify the late call forwarding values and to determine release causes even though ISUP REL release causes could be lost over international signaling links.
5. The SIM Toolkit approach to handle call returns and unreturned calls menu. Although SIM Toolkit is the primary focus, the invention also includes cases where computer programs operating on open platforms (e.g. Symbian, Linux, Window Mobile, J2ME, Brew) can be used to intercept calls and manage unreturned calls since similar concepts can be followed under these enabling technologies.

### DESCRIPTION OF THE DRAWINGS

FIG. 1 depicts an in-signaling-path-based architecture for return call service under the present invention.

FIG. 2 illustrates a new CAMEL/IN Trigger based call flow under the present invention.

FIG. 3 illustrates call flow under the present invention based on an existing CAMEL/IN trigger.

FIG. 4 depicts a monitoring-based architecture for return call service under the present invention.

FIG. 5 depicts a generic ISUP architecture for treating SRI-ACK errors in mobile-terminated call handling under the present invention.

FIG. 6 illustrates how a SIMM Toolkit client implementation under the present invention might receive an SMS of an unreturned call.

FIG. 7 illustrates a process under the present invention for delivering unreturned call information to the return call client.

FIG. 8 illustrates the flow of operations for initializing a SIM under the present invention.

FIG. 9 illustrates the flow of operations for listing returned and unreturned calls under the present invention.

FIG. 10 illustrates the process of call back and removing unreturned calls from a list of unreturned calls under the present invention.

FIG. 11 illustrates the process of handling call, USSD, and MO-SMS by a return call client under the present invention.

FIG. 12 illustrates the flow of operations for detecting or handling incoming calls that are not connected under the present invention.

FIG. 13 depicts a hierarchy of menus that can be available to an end user for operating an implementation of the present invention.

### DETAILED DESCRIPTION OF THE INVENTION

One aspect of the present invention relates to a client and server architecture for offering unreturned call management function. The client operates in conjunction with the end-user telecommunications hardware (either on the handset or SIM). For illustration purposes, a STK client will be used. A server would normally be on the telecommunications carrier network side. It can be in the signaling path based or monitor-based.

The server's role to capture caller ID of unreturned calls and send to the client. The client's role is to manage a menu of unreturned call caller Ids.

A basic embodiment contains the following steps:
1. A phone call is made to a subscriber
2. The call is unreturned either because the call went to a voicemail or because the call is not answered (e.g. powered off, out of coverage, busy, no-answering) and no voicemail is left (either because not subscribed or not left).
3. The caller ID of an unreturned call is captured by the network server, optionally with other pertinent information such as time of day.
4. The server sends unreturned call information comprising at least the caller ID of the unreturned call to the device
5. The client receives that information comprising at least caller ID and stores it on the device.
6. The end user can use the client to display and act upon a list of unreturned calls. The end user can also remove an unreturned call from the list or can make a call to an unreturned call caller ID
7. When the end user makes a call to the caller ID of one of the unreturned calls on that list, if the call is successful (e.g. duration longer than a configurable threshold, e.g. 10 sec), the unreturned call caller ID is removed from the list of unreturned calls.
8. Alternatively, the end user can interactively select to remove certain unreturned calls from the client's list of unreturned calls.

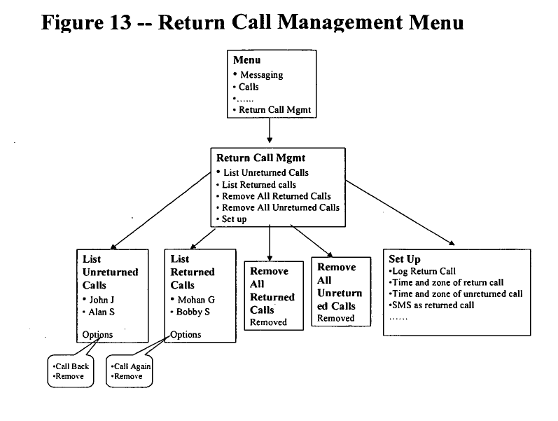

FIG. 13 shows a hierarchy of menu selections available to an end user to operate an embodiment of the unreturned call listing, interaction and management functions under the present invention.

Capture Caller ID of an Unreturned Call

There are two approaches to capturing the caller ID of an unreturned call: in-signaling-path approach and monitoring approach. Note that the concept of an unreturned call includes those that result in call forwarding and voicemail forwarding.

In an in-signaling-path based solution, a Camel T-CSI based approach will be detailed in this specification, although IN and ISUP-based embodiments are also possible. In a monitoring-based embodiment, all roaming links, HLR links, voicemail links, and A-interface will be monitored.

Under both approaches, there can also be an active ISUP signaling component to handle error conditions from HLR to GMSC where no forwarding happens.

In-Signaling-Path Approach

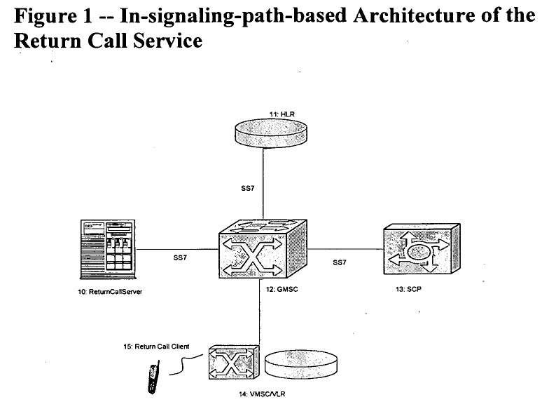

FIG. 1 depicts a general architecture of an in-signaling-path approach. Such an embodiment comprises a ReturnCallServer (10) in the SS7 signaling path of mobile terminated call of a subscriber of the return call service. Each time a call made to the subscriber reaches GMSC (12), GMSC (12) will download a profile of the subscriber from the HLR (11). GMSC (12) will pass the call control to the ReturnCallServer (10) which may relay the control back and forth to the SCP (13). ReturnCallServer will then send the captured unreturned call information to the Return Call Client (15) via the VMSCNLR (14) the subscriber is registered on.

Camel/IN-Based

In a CAMEL/IN-based embodiment, interception would be based on terminating Camel/IN triggers. When a MT call is made to a subscriber, a HPMN GMSC queries the HLR which returns the terminating trigger. The Trigger can be issued by GMSC via InitialDP to a ReturnCallServer system. The ReturnCallServer system can capture the caller ID, VMSC, IMSI/MSISDN etc of the subscriber.

If the IDP indicates an early call forwarding condition, ReturnCallServer can deduce the call as unreturned and issue Continue to GMSC-H. Otherwise it can then issue Camel/IN RRB on various conditions (busy, no answer, answer, disconnected) and Continue to GMSC-H. If the ERB from GMSC to ReturnCallServer later on indicates the call is unreturned, ReturnCallServer can issue Cancel to GMSC-H to drop the monitoring of other events.

In both cases, the ReturnCallServer can send the caller ID of the unreturned call using MAP MT FowardSMS to the captured VMSC with captured IMSI.

Since there may be existing terminating Camel/IN triggers for some subscribers (e.g. prepaid), at least two embodiments can be considered under the present invention. One is based on a new trigger. The other is based on an existing trigger.

New Camel/IN Trigger

The home operator defines a Camel/IN-based trigger (e.g. T-CSI) for a subscriber at the HPMN HLR. The trigger can be sent as part of an ACK to HPMN GMSC.

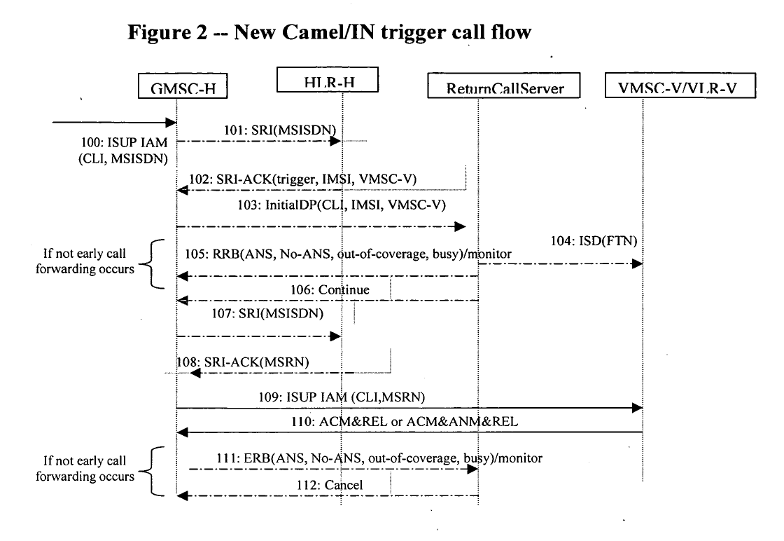

The signal flow depicted in FIG. 2 is described as follows.

100: CLI calls MSISDN. The MT call reaches HPMN GMSC-H

101: GMSC-H issues SRI(MSISDN) to HLR-H

102: HLR-H returns the terminating Camel/IN trigger to GMSC-H

103: GMSC-H issues InitialDP to ReturnCallServer system. The InitialDP will contain CallerID, VMSC-V, MSISDN/IMSI, subscriber state (busy, network unreachable) or early call forwarding pending status etc. IMSI is sent in Camel lnitialDP and some IN variants.

If certain information is not received, ReturnCallServer system can issue SRI-SM on MSISDN or SendParamaters on IMSI to HLR-H to get IMSI/MSISDN , VMSC-V, and subscriber state.

If early call forwarding conditions (e.g. IMSI detached, busy, network unreachable) occur, then ReturnCallServer can store the caller ID and time of the call for this unreturned call. It can then issue Continue. ReturnCallServer would not be further involved in the signaling path of the call.

Otherwise

104:
a. ReturnCallServer may use MAP SendParamaters to get call forwarding data
b. ReturnCallServer can execute a dynamic FTN manipulation method by issuing MAP ISD to VMSC (or VLR if known, e.g. from a mapping or from monitoring roaming links) with SSN=7 (rather than 8) to cancel all the forwarding values (or putting in some non-routable dummy values or a single special generic HPMN number). In the case of outbound roaming, since release causes might be lost in the ISUP REL messages when late call forwarding conditions occur, in the case that an outbound roamer has different late call forwarding values (e.g. CFB, CFNRy, CFNRc) for different conditions (e.g. busy, no-answer, non-reachable), special ranges of HPMN numbers could be used. The HPMN GMSC can be configured to route these numbers and the single special generic HPMN to ReturnCallServer. The special ranges can be divided into 3 pools (unreachable, no answer, busy). These pools can be used to assign an outbound roamer for its forwarding condition. When forwarding actually occurs, it can be routed back to GMSC-H which can then be ISUP IAM routed to the ReturnCallServer. The ReturnCallServer immediately can release the call via ISUP REL after deducing what forwarding condition for what outbound roamer actually occurred. Note that if all the call forwarding values are the same for different forwarding conditions, there may be no need to select a value from the 3 pools, rather the ReturnCallServer can cancel all forwarding values or put in some non-routable dummy values or the single special generic HPMN number.

105: ReturnCallServer would issue RRB on events (busy, answer, no answer, unreachable) in monitoring mode. If the ReturnCallServer is implemented as a feature of another application, then interrupt mode may be used.

106: ReturnCallServer then can issue CAP/IN Continue.

107: GMSC-H can then issue SRI again to HLR-H with CAMEL suppressed

108: HLR-H can return MSRN to GMSC-H

109: GMSC-H sets up the call to VMSC-V using ISUP IAM(CallerID, MSRN)

110: VMSC-V returns ISUP ACM followed REL or ANM

111: If ANM is received by GMSC-H, which can then send ERB(ANS) to ReturnCallServer which can in turn treat the call non-unreturned

If ANM is not received and late call forwarding conditions (busy, no answer or out of coverage) occur, then
VMSC-V can issue ISUP REL with release cause
GMSC-H can map these release causes to ERB events. A default (e.g. busy) can be used if release cause is unknown.
GMSC-H can issue ERB to ReturnCallServer in monitor mode. Recall interruptive mode can be used if the service is implemented as a feature within another application.
ReturnCallServer stores the Caller ID and time of the call as an unreturned call data.

Note here by “late call forwarding conditions”, we do not necessarily intend that late call forwarding actually happens since the late call forwarding values might be empty.

112: ReturnCall Server issues CAP/IN Cancel to GMSC-H. Exit. Existing Camel/IN trigger

This embodiment contemplates the case in which a home operator has previously defined a Camel/IN-based trigger (e.g. T-CSI) for a subscriber at the HPMN HLR. In this case, this trigger can be relayed thru a ReturnCallServer under the present invention.

The basic idea is to use SCCP routing to relay the terminating trigger via ReturnCallServer system. In this way, all CAP/IN transactions between GMSC-H and SCP can be relayed thru the ReturnCallServer.

The relay can be achieved in at least two ways.
1. Using translation type. In this method, GMSC-H can use a non-zero (e.g. 32) TT that translates gsmSCF from TCSI to SPC of the ReturnCallServer and a zero TT that translates the GT of ReturnCallServer to the SPC of the ReturnCallServer and translates the GT of gsmSCF to the SPC of the real gsmSCF. When IDP message is received, ReturnCallServer can set the SCCP CdPA TT of the relay out message to zero without changing routing indicator or SCCP CdPA GT of the gsmSCF. But the SCCP CgPA of the relay out message can be changed to the GT of the ReturnCallServer itself.
2. Using MTP level point code based routing. In this method, GMSC-H can just translate gsmSCF from TCSI to SPC of the ReturnCallServer with normal translation type (i.e. zero). When IDP message is received, ReturnCallServer can set the DPC of the relay out message to the real SPC of gsmSCF without changing routing indicator or SCCP CdPA except that the SCCP CgPA can be the GT of the ReturnCallServer itself.

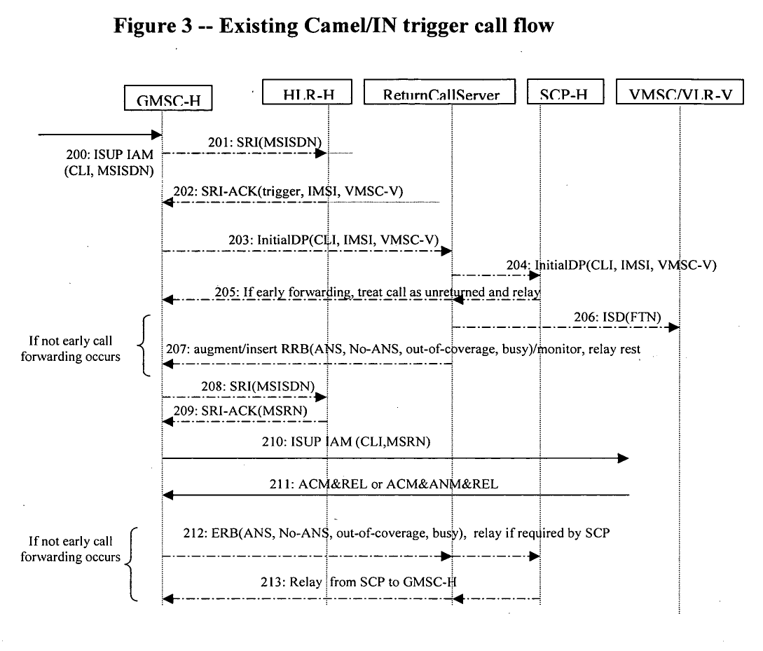

The signal flow depicted in FIG. 3 is described as follows.

200: CLI calls MSISDN. The MT call reaches HPMN GMSC-H

201: GMSC-H can issue SRI(MSISDN) to HLR-H

202: HLR-H can return the terminating Camel/IN trigger to GMSC-H

203: GMSC-H can issue InitialDP to ReturnCallServer system. The InitialDP can contain CallerID, VMSC-V, MSISDN/IMSI, subscriber state (busy, network unreachable) or early call forwarding pending status etc. IMSI is sent in Camel InitialDP and some IN variants. If certain information is not received, ReturnCallServer system can issue SRI-SM on MSISDN or SendParamaters on IMSI to HLR-H to get IMSI/MSISDN, VMSC-V, and subscriber state.

205: ReturnCallServer can relay IDP to the real SCP.

If early call forwarding conditions (e.g. IMSI detached, busy, network unreachable) occurs (based on information obtained at step 203 and new forwarding number from the real SCP), then ReturnCallServer can store the caller ID and time of the call for this unreturned call.

206: ReturnCallServer may use MAP SendParamaters to get call forwarding data. ReturnCallServer will execute a dynamic FTN manipulation method by issuing MAP ISD to VMSC (or VLR if known, e.g. from a mapping or from monitoring roaming links) with SSN=7 (rather than 8) to cancel all the forwarding values (or putting in some non-routable dummy values or a single special generic HPMN number). In the case of outbound roaming, since release causes might be lost in the ISUP REL messages when late call forwarding conditions occur, in the case that an outbound roamer has different late call forwarding values (including without limitation CFB, CFNRy, CFNRC) for different conditions (including without limitation busy, no-answer, non-reachable), special ranges of HPMN numbers could be used. The HPMN GMSC can be configured to route these numbers and the single special generic HPMN to ReturnCallServer. The special ranges can be divided into three pools (unreachable, no answer, busy). These pools can be used to assign an outbound roamer for its forwarding condition. When a forwarding actually occurs, it can be routed back to GMSC-H which will then be ISUP IAM routed to the ReturnCallServer. The ReturnCallServer immediately releases the call via ISUP REL after deducing what forwarding condition for what outbound roamer actually occurred. Note that if all of the call forwarding values are the same for different forwarding conditions, there may be no need to select a value from the three pools, rather just the ReturnCall Server can cancel all forwarding values or putting in some non-routable dummy values or the single special generic HPMN number.

207: ReturnCallServer can relay (possibly modified, e.g. RRB) SCP CAP/IN response to GMSC-H. If the SCP sends a RRB, ReturnCallServer can augment it on any missing events in (busy, answer, no answer, unreachable) in monitoring mode for any missing event. If the SCP does not send a RRB, ReturnCallServer can insert RRB (before relaying SCP's message to GMSC-H) to GMSC-H (busy, answer, no answer, unreachable) in monitoring mode. If the ReturnCallServer is implemented as a feature of another application, then interrupt mode may be used.

208: GMSC-H can then issue SRI again to HLR-H with CAMEL suppressed

209: HLR-H returns MSRN to GMSC-H

210: GMSC-H can set up the call to VMSC-V using ISUP IAM(CallerID, MSRN)

211: VMSC-V can return ISUP ACM followed REL or ANM

212: If ANM is received by GMSC-H, which can then send ERB(ANS) to ReturnCallServer which can then treat the call non-unreturned and drop any stored information about the call. If the SCP is waiting for ANS event, the ERB can be relayed to the SCP.

If ANM is not received and late call forwarding conditions (busy, no answer or out of coverage) occur, then
a. VMSC-V can issue ISUP REL with release cause
b. GMSC-H will map these release causes to ERB events. A default (e.g. busy) can be used if release cause is unknown.
c. GMSC issues ERB to ReturnCallServer in required mode from RRB.
d. ReturnCallServer will relay that to the SCP if SCP issued RRB on the events
e. ReturnCallServer stores the Caller ID and time of the call as an unreturned call data.

Note here by “late call forwarding conditions”, it does not mean actually late call forwarding happens since the late call forwarding values might be empty. 213: ReturnCallServer will relay what SCP sends to GMSC-H

Monitoring-Based

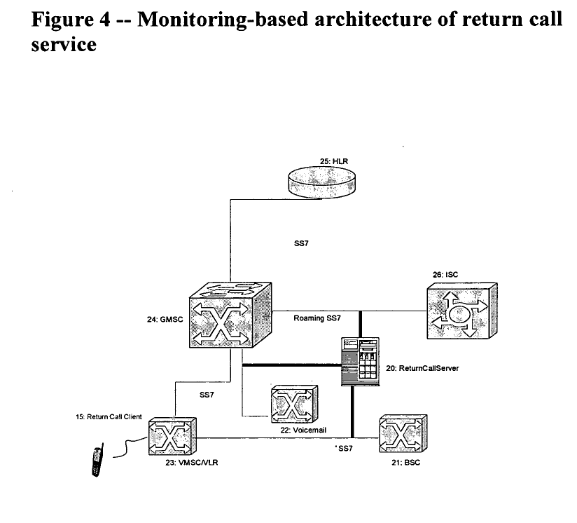

FIG. 4 depicts the architecture of a monitoring-based embodiment of the present invention. A ReturnCallServer (20) is for monitoring MAP and ISUP messages at roaming links between a GMSC (24) and a ISC (26), monitoring ISUP messages at Voicemail (22) links and monitoring at A-interface between a BSC (21) and a VLR/VMSC (23). Other links (such as between GMSC (24) and HLR (25)) might also be monitored.

Monitoring Roaming Links

At roaming links, MAP LUP and ISD monitoring will produce IMSI, VMSCNLR and MSISDN data. MAP PRN monitoring will produce IMSI, MSRN mapping. ISUP IAM monitoring will produce Caller ID and MSRN relationships. From these, all associations can be established.

If ISUP ANM is not monitored or ISUP CPG monitored indicates late call forwarding or MAP PRN message indicates error or early call forwarding or MAP monitoring found RCH (for optimal routing for late call forwarding) for a call, the call is considered unreturned. Note here “unreturned call” include those resulted in call forwarding (e.g. to voicemail).

Dynamic FTN manipulation can also be used in the monitoring approach. On monitoring ISD on FTNs on roaming links, dynamic FTN can be initiated to avoid tromboning in late call forwarding.

Voicemail Links Monitoring

At voicemail links, if call forwarding to voicemail (early call forwarding or late call forwarding) is monitored for a call, the call is considered to be unreturned. By looking at the ISUP IAM messages going thru the voicemail links, if the OCN or RGN parameters can be located, ReturnCallServer can deduce for which MSISDN the call is unreturned.

Monitoring voicemail links to capture unreturned calls of a subscriber will always be effective for early call forwarding including CFU whether the subscriber is at home or roaming. In HPMN or home country late call forwarding, OCN or RGN are generally captured. However in roaming cases, OCN or RGN parameters in ISUP IAM are generally lost over international signaling links. Monitoring voicemail links for international late call forwarding will not be effective.

A-Interface Monitoring

At A-interface, if a late call forwarding condition (e.g. out of coverage/unreachable, no answer or busy) is monitored for a call, the call can be considered to be unreturned for the purposes of the present invention.

A interface monitoring can be expensive if the operator has too many MSCs. If only late call forwarding to voicemail is interested, A interface monitoring can be omitted and only voicemail links monitoring will be sufficient.

Negative Response to Routing Information Request

Both the in-signaling path approach and the monitoring approach may also be improved, enhanced or enabled by a function to deal with SRI-ACK error cases. The error case can happen in the first SRI query to HLR from GMSC on a MT call to a subscriber or in the subsequent SRI query when T-CSI is downloaded to GMSC from HLR in the first SRI-ACK and ReturnCallServer responds control back to GMSC after receiving IDP from the GMSC-H.

The negative response to an SRI information element can assume or take at least the following values:
absent subscriber;
bearer service not provisioned;
call barred (Operator determined barring);
call barred (Supplementary service barring);
CUG reject (Called party SS interaction violation);
CUG reject (Incoming calls barred within CUG);
CUG reject (Requested basic service violates CUG constraints);
CUG reject (Subscriber not member of CUG);
data missing;
facility not supported;
forwarding violation
number changed;
system Failure;
teleservice not provisioned;
unexpected data value;
unknown subscriber.

Here are three options for dealing with unreturned calls from these error conditions.
1. GMSC can be configured on receiving some of these error codes (or their corresponding ISUP REL causes, e.g. absent subscriber, incoming call barred) to route the call to ReturnCallServer.
2. GMSC can configure an EOS (end of selection) routing table to route all unroutable calls to returnCallServer
3. HLR can define a default or special call forwarding number for Absent Subscriber or Incoming Call barred or any specific condition.

On receiving such forwarded calls, a ReturnCallServer can capture at least the caller ID, called party and time of the call.

Here are three options for implementing an ISUP interface on the ReturnCallServer
1. ISUP direct interface. In this case, on receiving ISUP IAM from GMSC-H, ReturnCallServer will just issue ISUL REL with a configurable release cause code after capturing all the relevant information from IAM. The cause code will be used to direct switch environment to play a certain announcement.
2. ISUP direct interface with voice path. In this case, on receiving ISUP IAM from GMSC-H, ReturnCallServer can play a voice response and then release the call after capturing all the relevant information from IAM.
3. ISUP loopback. GMSC is configured to loop the call signaling thru ReturnCallServer without looping call path thru ReturnCallServer. On receiving ISUP IAM from GMSC-H, ReturnCallServer will just issue ISUL IAM(voice-number) with a configurable voice-number after capturing all the relevant information from IAM. The voice-number will be used to direct switch environment to play a certain announcement.

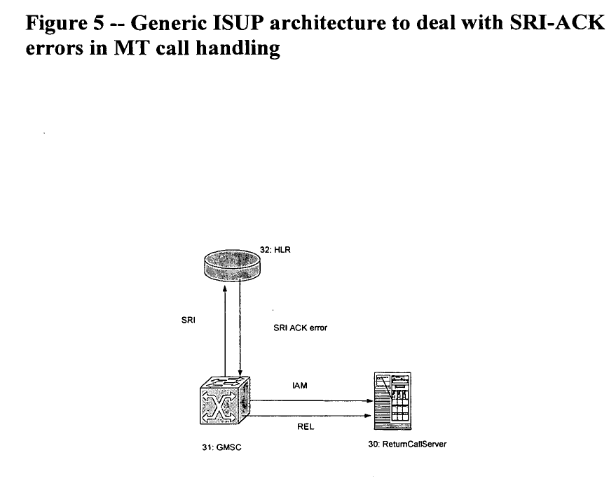

The generic architecture of all the above ISUP implemented is depicted in FIG. 5. It consists of a Return Call Server (30) connected via an ISUP interface to GMSC (31) which is connected via a SS7 interface to the HLR (32).

In-Signaling Path Approach vs Monitored Embodiments

Those skilled in the art may appreciate a trade-off that is possible to consider when weighing between or implementing these two different embodiments of the present invention. A monitored approach is non-intrusive but might not cover all cases of unreturned calls. For example, ISUP CPG and MAP RCH at roaming links might not be observed to indicate late call forwarding. Late call forwarding to voicemail or ReturnCallServer might not contain the OCN or RGN for which to deduce whose call is unreturned. In addition, roaming late call forwarding to non-voicemail case will not be captured if only voicemail links monitoring are used to detect late call forwarding.

An in-signaling path embodiment is intrusive, but can capture various call forwarding conditions. However it may rely upon elements such as MAP ISD to reset late call forwarding values to empty or dummy numbers or special numbers.

A Monitoring embodiment also involves A-interface to cover local late call forwarding cases beyond voicemail forwarding. This can be an expensive option. But with the help of an Unreturned Call Client in the device side, the device side can capture Unreturned Caller Ids of incoming calls of the cases of (non-answered, busy/call-waiting) in the local network although out of coverage case cannot be captured.

To be sure, a Monitoring approach and an in-signaling path embodiment can be mixed to produce a hybrid approach to capture the caller ID of an unreturned call. Delivering to handset and receiving in the handset of unreturned call caller ID

Once the caller ID of an unreturned call is captured, the ReturnCallServer can send the caller ID to the handset MSISDN via a MT SMS.

If the handset is detached/busy either known before SMS is delivered or known after SMS has failed to deliver, then ReturnCallServer can send MAP DeliverReport to HLR to register for AlertSC later for the same SMS delivery when the handset is re-attached or not busy again later.

Similarly, if the handset is out of coverage or memory capacity exceeded, then ReturnCallServer can send MAP DeliverReport to HLR to register for AlertSC later for the same SMS delivery when the handset is in coverage or has free memory again later.

The MT SMS can have a protocol ID indicating an SMS for the ME if the device client is on the handset and will have a protocol ID indicating an SMS for the SIM if the device client is on the SIM according to GSM-340 on the protocol ID byte. The protocol can be as follows:

In the case where bit 7=0, bit 6=1, bits 5 . . . 0 are used as defined below
5 . . . 0
000000 Short Message Type 0
000001 Replace Short Message Type 1
000010 Replace Short Message Type 2
000011 Replace Short Message Type 3
000100 Replace Short Message Type 4
000101 Replace Short Message Type 5
000110 Replace Short Message Type 6
000111 Replace Short Message Type 7
001000..011110 Reserved
011111 Return Call Message
100000..111100 Reserved
111101 ME Data download
111110 ME De-personalization Short Message
111111 SIM Data download

A short message type 0 indicates that the ME must acknowledge receipt of the short message but may discard its contents.

The Replace Short Message feature is optional for the ME and the SIM but if implemented it shall be performed as described here.

For MT short messages, on receipt of a short message from the SC, the MS can check to see if the associated Protocol Identifier contains a Replace Short Message Type code. If such a code is present, then the MS can check the originating address and replace any existing stored message having the same Protocol Identifier code and originating address with the new short message and other parameter values. If there is no message to be replaced, the MS can store the message in the normal way. The MS may also check the SC address as well as the Originating Address. However, in a network which has multiple SCs, it is possible for a Replace Message type for a SM to be sent via different SCs and so it is recommended that the SC address should not be checked by the MS unless the application specifically requires such a check. If a Replace Short Message Type code is not present then the MS will store the message in the normal way. In MO short messages the SC reacts similarly but only the address of the originating MS or any other source is checked.

A Return Call Message can indicate to the MS that it should inform the user that a call (e.g. a telephone call) can be established to the address specified within the TP-OA. The RP-OA contains the address of the SC as is standard. The message content (if present) can give displayable information (e.g. the number of waiting voice messages). The message can be handled in the same way as all other messages of the Replace Short Message Types.

That ME De-personalization Short Message is a ME-specific message which instructs the ME to de-personalities the ME (see GSM 02.22). The TP-DCS shall be set to Uncompressed, Default Alphabet, and Message Class 1 (ME-specific), which corresponds to a bit coding of 00010001. The TP-UD field contains de-personalization information coded according to GSM 02.22. This information shall not be displayed by an ME which supports the scheme. The acknowledgement to this message is a SMS-DELIVER-REPORT for RP-ACK in which the TP-User-Data shall be coded according to GSM 02.22.

SIM Data download is a facility whereby the ME must pass the short message in its entirety including all SMS elements obtained in the SMS deliver to the SIM using the mechanism described in GSM 11.11. The DCS shall be set to 8 bit message class 2 (either bit coding 11110110 or 00010110). The entire user data field is available for SIM Data download.

ME Data download is a facility whereby the ME shall process the short message in its entirety including all SMS elements contained in the SMS deliver to the ME. The DCS shall be set to message class 1. The entire user data field is available for ME data download.

The last two protocol Ids are what the ReturnCallServer uses to deliver the caller ID to the recipient's device. For device proprietary clients, J2ME, Brew, Symbian, Linux and Window Mobile clients, ME data download is more relevant. However we will use SIM Data Download to illustrate the STK application in this patent although the framework also covers the ME data download case for non-STK clients.

For the STK example application to work, the service “data download via SMS Point-to-point” may be allocated and activated in the SIM Service Table (see GSM 11.11), then the ME would follow the procedure when the ME receives a Short Message with: protocol identifier=SIM data download, and data coding scheme=class 2 message,

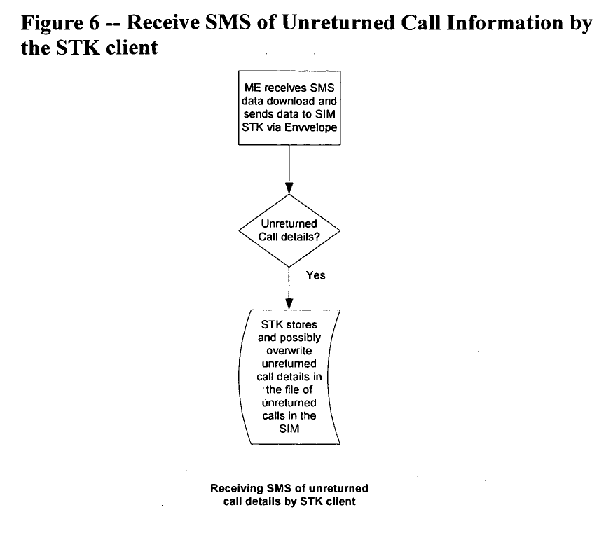

The device client can be configured to listening on the incoming SMS data (ME-bound or SIM bound) event by Set Up Event proactive SIM command. When the client receives the SMS containing the caller ID and time/timezone of an unreturned call, the client can store the caller ID and the time/timezone of the unreturned call in the device (e.g. a SIM file). If the caller ID is already on the device, the new time/timezone of the call can overwrite the previous one. The flow is briefly depicted in FIG. 6.

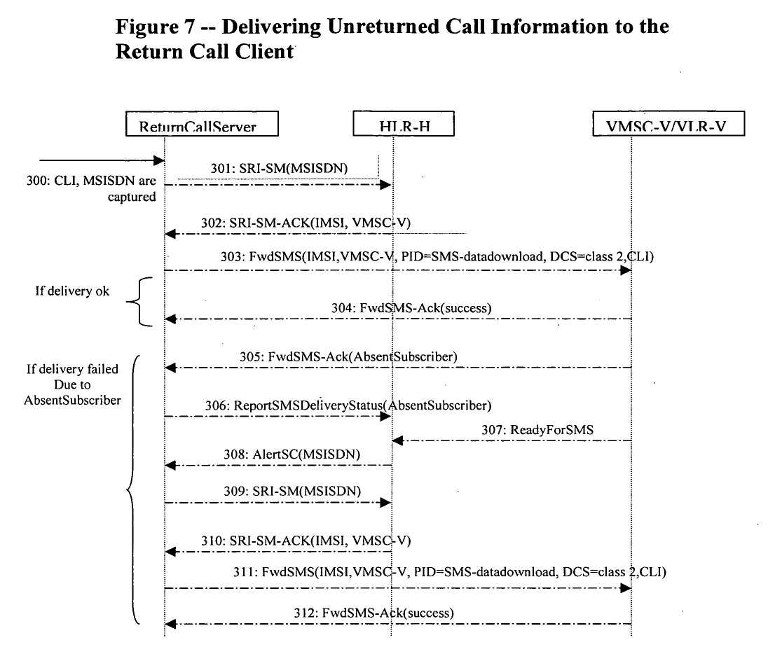

The signal flow depicted in FIG. 7 is described below.

300: ReturnCallServer captures CLI and MSISDN of a call

301: ReturnCallServer issues SRI-SM(MSISDN) on the recipient's MSISDN to HLR to obtain IMSI and VMSC if they are not known from in-signaling path interception or monitoring

If detached/busy, ReturnCallServer sends delivery report to HLR for later AlertSC

Otherwise

303: ReturnCallServer issues MT-ForwardSMS(SM-RP-OA=ReturnCallServer-GT, SM-RP-DA=IMSI, VMSC, SM-RP-UI(TP-PDU-PID=SIM-data-download,DCS=class-2, CLI))

304: If the SMS delivery is successful, VMSC will return FwdSMS-ACK success.

305: If detached, out-of-coverage, or busy or memory capacity exceeded, VMSC will return FwdSMS-ACK with failure reason

306: ReturnCallServer sends delivery report via MAP ReportSMSDeliveryStatus to HLR

307: When the MS becomes available for receiving SMS, VLR will issue ReadyForSMS to HLR

308: HLR will send MAP AlertSC to ReturnCallServer

309: ReturnCallServer will then issue MAP SRI-SM to HLR again

310: HLR will return VMSC address to ReturnCallServer

311: ReturnCallServer will attempt the SMS delivery again to VMSC using MAP FwdSMS.

312: If success, VMSC will issue FwdSMS-Ack(success) to ReturnCallServer

If not, ReturnCallServer will issue ReportForSMSDelivery Status to HLR, when HLR sends AlertSC to ReturnCallServer on MSISDN, ReturnCallServer will start again. There may be retries configurable by number of times and retry intervals.

Return Call Client

An STK-based Return Call Client embodiment can be implemented using Proactive SIM commands and SIM application either using SIM proprietary language or using Java Card API standard. The exact form of the language is just an implementation detail.

The Proactive SIM can provide a mechanism whereby the SIM can initiate actions to be taken by the ME. These actions may include at least the following:
displaying text from the SIM to the ME;
sending a short message;
setting up a voice call to a number held by the SIM;
setting up a data call to a number and bearer capabilities held by the SIM;
sending a SS control or USSD string;
playing tone in earpiece;
initiating a dialogue with the user;
SIM initialization request and notification of changes to EF(s);
providing local information from the ME to the SIM;
communicating with the additional card(s) (if class “a” is supported);
providing information about the additional card reader(s) (if class “a” is supported);
managing timers running physically in the ME;
running an AT command received from the SIM, and returning the result to the SIM (if class “b” is supported);
sending DTMF;
requesting the ME to launch the browser corresponding to a URL. (if class “c” is supported);
establishing and managing a bearer independent protocol (if class “e” is supported).

For each command involved in the dialog with the user, a help information may be available, either for each item of a list of items proposed to the user, or with each command requesting a response from the user. If a proactive command involved in the dialog with the user indicates the availability of the help feature, the support of this feature is optional for the ME.

A set of possible menu entries is supplied by the SIM in a proactive SIM command “Set up Menu”. The menu selection mechanism is used to transfer the SIM application menu item which has been selected by the user to the SIM. The menu selection mechanism may also be used for requesting help information on the items of the SIM application menu.

the SIM must be allocated and activated for proactive SIM support, menu, relevant event download, call control support. The handset should also support all these capability even though it does not fall into any of the letter class (a,b,c,d,e) of special handsets.

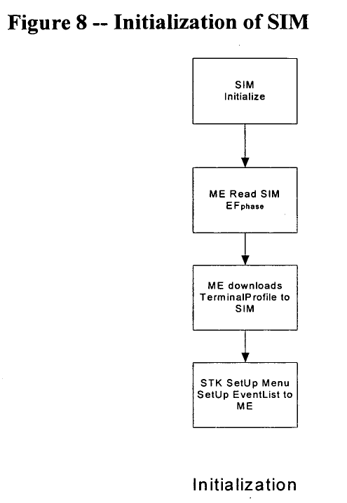

Each subscriber of Return Call Management service can be issued a STK-able SIM with the Return Call Client. When the SIM is initialized in a handset, the handset will be initiate Profile downloading which provides a mechanism for the ME to tell the SIM what it is capable of. The ME knows what the SIM is capable of through the SIM Service Table and EFPHASE. The initialization of SIM is depicted in FIG. 8.

When terminal profile is downloaded to the SIM, the STK application can set up the events to listen to SMS data download to SIM and the menu on the device.

The SIM shall use the Set Up Event List to supply a set of events. This set of events would become the current list of events for which the ME is to monitor. Any subsequent SET UP EVENT LIST command replaces the current list of events supplied in the previous SET UPEVENT LIST command. The SET UP EVENT LIST command can also be used to remove the entire list of events current in the ME.

The list of events provided by the SIM in the last SET UP EVENT LIST command would be removed if the ME is powered off or the SIM is removed or electrically reset. When the ME has successfully accepted or removed the list of events, it would send TERMINAL RESPONSE (OK) to the SIM. When the ME is not able to successfully accept or remove the list of events, it shall send TERMINAL RESPONSE (Command beyond ME's capabilities). When one of the events in the current list occurs, then the ME could use the Event Download mechanism to transfer details of the event to the SIM.

The events to monitor by the STK application client on Unreturned Calls Management will include “Call Control”, “MO-SMS Control”, “Incoming Call”, “Call Connected”, “Call Disconnected”, “SMS Data download”, “Menu selection” etc. When these events happen, the ME will pass via Envelope to the SIM STK application.

The SIM should use Set Up Menu to set up the menu on the ME. The top menu item will be something like “Unreturned Calls Management”. When selected, the STK application will present a menu of five items called something like “List Unreturned Calls”, “List Returned Calls”, “Remove All Unreturned Calls”, “Remove All returned Calls” and “Set Up”. They will be integrated into the ME menu seamlessly and will not be removed by subsequent Set Up Menu Commands.

The STK application will involve three files:
the file of Unreturned Calls which contains a list of unreturned calls the file of Returned Calls which contains the list of returned calls the file of set up which contains the user preference of unreturned calls management

When the “Remove All Unreturned Calls” menu item is selected, the STK application will erase content in the Unreturned Calls File in the SIM.

When the “Remove All returned Calls” menu item is selected, the STK application will erase content in the Returned Calls File in the SIM.

When the “Set up” menu item is selected, the STK application will present the user to a list of options:
Of whether to save the unreturned caller ID (could be limited to those without a name matching in the phone book) in a file of called back caller IDs in the SIM when the user has made a call back to the unreturned caller ID. The default is to save. The other option is not to save.
Of whether to list time and time zone of an unreturned call
Of whether to list time and time zone of a returned call
Of whether to include MO-SMS as a return to an unreturned call

When the “List Unreturned Calls” menu item is selected, the STK application will set up the menu of a list of unreturned calls. The maximum amount of data sent in one proactive SIM command is 256 bytes. So there would be a trade-off between the number of items and the length of the descriptive text (the alpha identifier of the SET-UP MENU command and the text strings of the items), e.g. for an average length of 10 bytes per text string the maximum amount of items is 18. The list of menu items would then be part of the menu system of the ME and the user is allowed to select an item from this list. The presentation style is left as an implementation decision to the ME manufacturer. However, the ME shall present the menu items in the order given by the SIM, unless instructed otherwise by the user, or when this would be inappropriate for the presentation style of the ME. The menu provided by the SIM in the last SET UP MENU command shall no longer be part of the menu system of the ME if the ME is powered off or the SIM is removed or electrically reset, Any subsequent SET-UP MENU command replaces the current list of menu items supplied in the previous SET-UP MENU command. The SET-UP MENU command can also be used to remove a menu from the menu system in the ME.

For better presentation purpose, practitioners might consider limiting the list to a maximum of 9 items (so number key can be used as well as high-light selection) where the 9^{th} one will be “Next” for next list if there are more than 9 and just the 9^{th} unreturned caller ID if there are only 9 unreturned calls.

For subsequent list, the first menu item will be “Prev” and the 9^{th} menu item will be “Next” for next list if there are more than 9 in the following and just the 9^{th} unreturned caller ID if there are no more unreturned calls.

Each item will also list the time and time zone of the “unreturned call” if the set up option sets that way.

When the “List Returned Calls” menu item is selected, the STK application will list all returned calls in similar way as the “List Unreturned Calls” case except this list will be those from the file of returned calls. Also that each item will also list the return time and time zone of the “returned call” if the set up option sets that way.

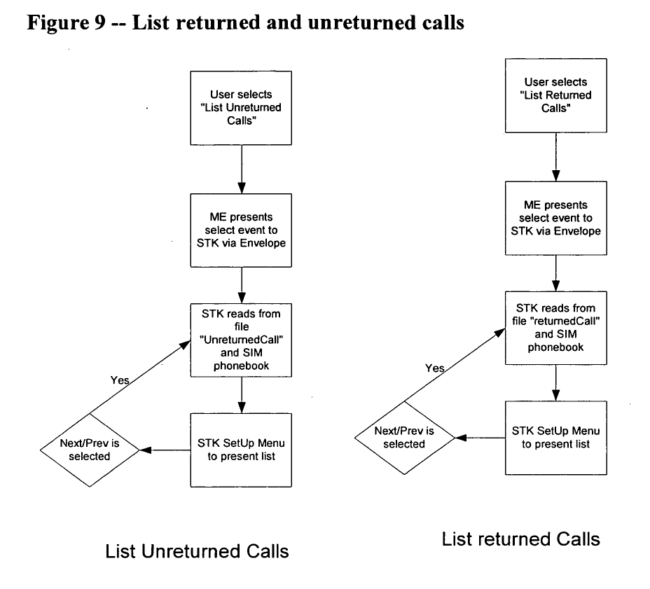

The process of listing returned and unreturned calls is depicted in FIG. 9.

The STK application will use the contact list file on the SIM to map unreturned caller ID to names in the phone book to present name as an item if the caller ID has a matching name and present the caller ID as an item if the caller has no-matching name. This also requires the user need to store a phone book copy in the SIM. The SIM will be assumed large enough to store phone book.

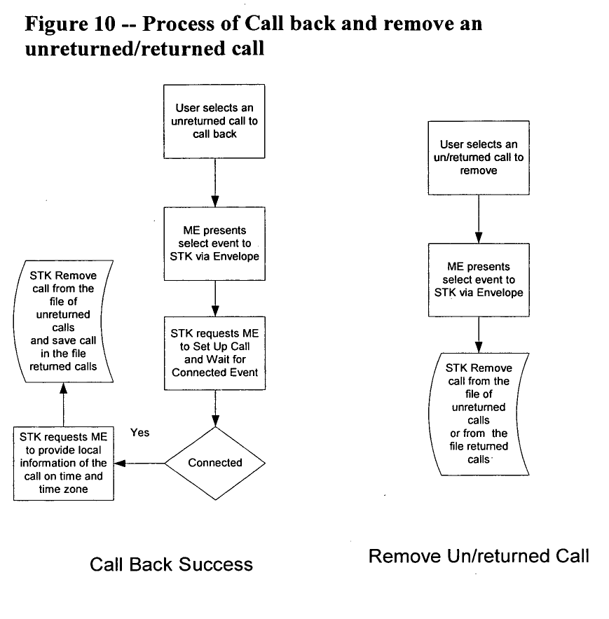

The process of call back an unreturned call and removing a returned/unreturned call from a list is depicted in FIG. 10.

Today, many users put phone book on the ME side of the device for reasons of better contact details e.g. email address. The non-STK client approach (e.g.Brew, J2ME, from open mobile OS such as Symbian, Window Mobile, Palm etc) will be able to access this phone book. However the STK application approach will require they save a copy in the SIM as well if name matching is needed.

Softkey options can also be used to initiate call back or remove the selected item. Otherwise, when an item is selected, the STK application will present remove and call back option.

When removing option is selected on an unreturned call, the STK application will remove the unreturned caller ID from the unreturned call file in the SIM.

When a call back option is selected on an unreturned call, the STK application will remove the unreturned caller ID from the unreturned call file in the SIM. It will also save the caller ID into the file of returned calls if the option is set up that way. If there is already a returned call entry, the previous one will be overwritten with the new time and time zone.

The current time and time zone will be returned to SIM STK by the ME in response to a SIM STK Proactive Command “Provide Local Information”.

Intercept Call Back and SMS to Unreturned Calls

The STK will Set Up Event list to include “Call Control” event. When this service is activated by the SIM, all dialled digit strings, supplementary service control strings and USSD strings are first passed to the SIM before the ME sets up the call, the supplementary service operation or the USSD operation. The ME shall also pass to the SIM at the same time its current serving cell. The SIM has the ability to allow, bar or modify the call, the supplementary service operation or the USSD operation. The SIM also has the ability to replace a call request, a supplementary service operation or a USSD operation by another call request or supplementary service operation or USSD operation. For example, a call request can be replaced by a supplementary service operation or a USSD operation, and vice-versa.

The STK will also Set Up Event list to include “Incoming Call” and “Connected” (POSSIBLY and “Disconnected” if the duration of the call is used to measure if an unreturned call is truly returned or not) events.

When call information is passed by the ME to the SIM STK application via Envelope(Call Control), the STK application would check if the call is supplementary service. If it is supplementary, the STK application will let the call proceed unchanged. Otherwise, the STK application could check if the call is to a number in the file of unreturned calls. Here the check might also include USSD call back if the HPMN operator supports USSD call back.

If the check returns negative, the STK application could let the call proceed unchanged. Otherwise, if the check indicates a non-USSD call, the STK application could wait for the Connected event of the call after letting the call proceed unchanged. If the check indicates a USSD call back, the STK application could wait for the Incoming Call event and then the Connected event.

If the Connected event is received for a call waited by the STK application, the STK application will consider the call returned.

The STK can also optionally Set Up Event list to include “MO-SMS control” event depending on the set up option mentioned above. When this service is activated by the SIM, all MO short messages are first passed to the SIM before the ME sends the short message. The ME shall also pass to the SIM at the same time its current serving cell. The SIM shall have the ability to allow the sending, bar the sending or modify the destination address of the short message before sending it.

When a MO-SMS is passed thru the STK application via Envelope(MO-SMS Control) by the ME, the SIM application can check if the SMS TP-DA is a number in the file of unreturned calls in the SIM.

If the check returns negative, the STK application can let the MO-SMS proceed as unchanged. Otherwise, the STK application can also let the MO-SMS proceed as unchanged but may also save the SMS as returned call in the file of returned calls in the SIM. The returned call detail would indicate it's a SMS return rather than a true call return.

In all cases, when a call is returned via normal call, USSD or SMS, the STK application will remove the call details from the file of unreturned calls in the SIM. It will also save the call details to the file of returned calls in the SIM if the set up option indicates so. The saved call details could also include time and time zone depend on the user set up option. If the set up option is to include time and time zone, then the STP application will issue Provide Local Information to the ME to find out the time and time zone.

When saving the returned call details in the file of returned calls in the SIM, the STK application will also mark if the returned call is made via USSD call back, SMS or just normal call (default).

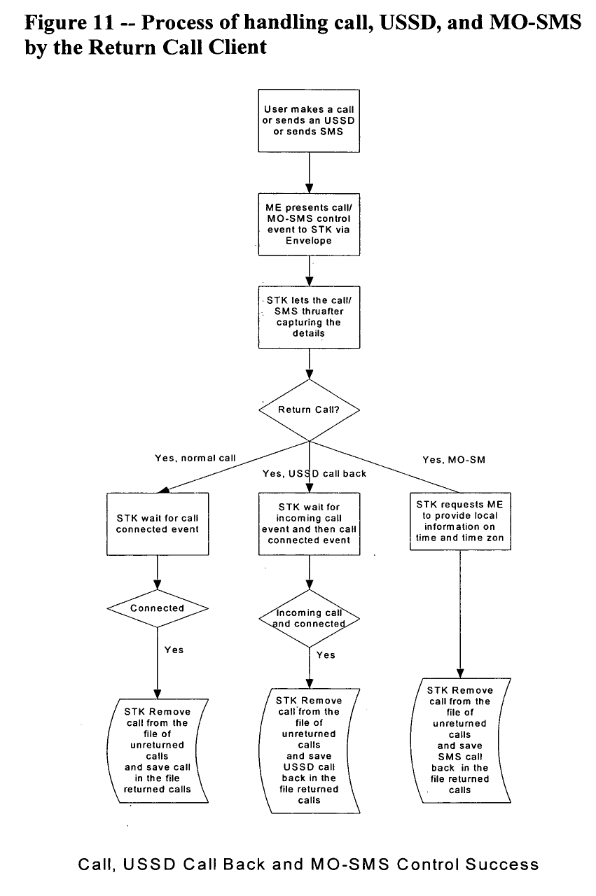

The process of handling call, USSD, MO-SMS is depicted in FIG. 11.

Incoming Call Event for CLI Capture by the Client

Since the STK's Set Up Event list to includes “Incoming Call” monitoring, it is also possible for the client to capture the caller ID of a non-answered call including (unanswered, busy/call waiting).

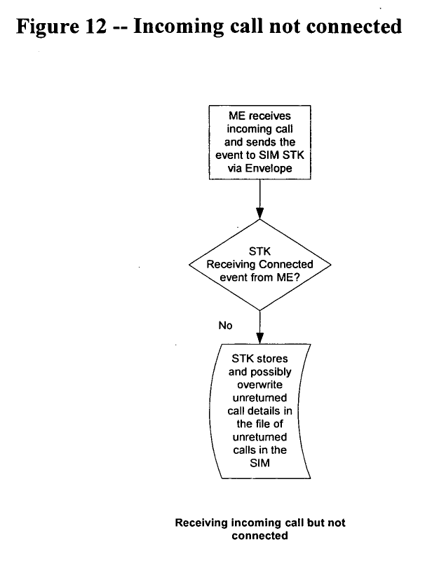

After receiving the “Incoming Call” event call details and the caller ID is captured, the client waits for the “Connected” event. If the “Connected” event is not received within a configurable interval, the client will store the caller ID in the file of unreturned calls in the SIM. This process is depicted in FIG. 12.

Cases can not be Handled by the Return Call Service

Many voicemail systems today support caller ID capture. The subscriber can return calls within the voicemail system. If the subscriber checks a voicemail and returned the call within the voicemail system, this may not be captured by the Unreturned Call Management Client. In this case, the subscriber may have to explicitly remove the unreturned call from the list using the STK menu.

If the caller called on a device (e.g. public phone) that he does not want the recipient to call back on, then the Unreturned Calls Management System wont be able to indicate this. For example, the caller can leave call back details on a voicemail system that is different from his caller ID.

If the subscriber uses USSD to call back, when the next incoming call comes to the mobile device without the caller ID to be recognized as a call-back, then its possible that the call comes from a new call happening concurrently. When that happens, the call might be mistreated as a call return to an unreturned call. If the incoming call must have the caller ID to be recognized as a call back for the client to treat that as a return call, then some call-backs will not be recognized as call-backs. In this case, the subscriber would have to explicitly remove the unreturned call from the list of unreturned calls using SIM menu.

Of course, the system cannot handle cases where the subscriber sends a SMS or make a call to indicate call back again.

I. Abbreviations and Terms of Art

ACM: ISUP Address Complete Message
ANM: ISUP ANSWER message
BCD: Binary Coded Decimal
BCSM Basic Call State Model
CAMEL Customized Applications for Mobile network Enhanced Logic
CAP: Camel Application Protocol
CFB: Conditional Call Forwarding on Busy
CFNRc: Conditional Call Forwarding on Non-Reachable
CFNRy: Conditional Call Forwarding on Non-Reply
CFU: Unconditional Call Forwarding
CLI: Calling Line Identification
CSI: Camel Subscription Information
DCS: Data Coding Scheme
DCS: Date Coding Scheme
DP Detection Point
DPC: Destination Point Code
EDP Event Detection Point
GMSC Gateway MSC
GMSC-H: HPMN Gateway MSC
gsmSCF GSM Service Control Function
gsmSRF GSM Specialized Resource Function
gsmSSF GSM Service Switching Function
HLR Home Location Register
HLR: Home Location Register
HLR-H: HLR from HPMN
HPLMN Home PLMN
HPMN: Home Public Mobile Network
IAM: ISUP Initial Address Message
IDP: lnitialDP IN message
IE Information Element
IF Information Flow
IMSI: International Mobile Subscriber Identifier
IN: Intelligent Network protocol
IP Intelligent Peripheral
IPLMN Interrogating PLMN
ISD: MAP Insert Subscriber Data
ISG: International Signal Gateway
ISUP: ISDN User Part
LUP: MAP Location Update
ME: Mobile Equipment
MSC Mobile service Switching Center
MSC: Mobile Switch Center
MSISDN: Mobile Subscriber ISDN
MSRN: Mobile Station Roaming Number
NA North American
O-BCSM Originating Basic Call State Model
OCN: Original Called Number
O-CSI Originating CAMEL Subscription Information
ODB Operator Determined Barring
OSS Operator Specific Service
PIC Point In Call
PLMN Public Land Mobile Network
PRN: Provide Roaming Number
RCH: MAP Resume Call Handling
RGN: Redirecting Number
SCCP: Signal Connection Control part
SCP: Signal Control Point
SLPI Service Logic Program Instance
SMF Service Management Function
SPC: Signal Point Code
SRI: Send Routing Information
SRI-SM: Send Routing Information For Short Message
SS7: Signaling System 7
SS-CSI Supplementary Service Notification CAMEL Subscription Information
STP: Signal Transfer Point
STP-H: HPMN STP
T-BCSM Terminating Basic Call State Model
T-CSI Terminating CAMEL Subscription Information
T-CSI: Terminating CSI
TDP Trigger Detection Point
TIF-CSI Translation Information Flag
TP-DA: SMS transfer protocol destination address
U-CSI USSD CAMEL Subscription Information
UG-CSI USSD General CAMEL Service Information
USSD: Unstructured Supplementary Service Data
VHE: Virtual Home Environment
VLR Visitor Location Register
VLR: Visit Location Register
VLR-V: VLR from VPMN
VMSC: Visit Mobile Switch Center
VMSC-V VMSC from VPMN
VPLMN Visited PLMN
VPMN: Visited Public Mobile Network
   II. Other Variations

Provided above for the edification of those of ordinary skill in the art, and not as a limitation on the scope of the invention are detailed illustrations of a scheme for presenting and displaying CLI to subscriber telecommunications stations functioning outside of the home or accustomed telecommunications carrier network. Numerous variations and modifications within the spirit of the present invention will of course occur to those of ordinary skill in the art in view of the embodiments that have now been disclosed. For example, while in the described embodiments, the present invention is implemented primarily from the point of view of common-carrier networks of voice telecommunications by mobile means, the present invention may also be effectively implemented for any facility capable of providing telecommunications and any device capable of receiving caller-id type information, storing it and displaying it for interaction by a user. That can include customer premises equipment in any POTS network, pagers or two-way text messaging devices, internet instant messaging means such as AIM, MSN Messenger, ICQ, Skype, Net2Phone or others. It could also include remote multiplayer gaming platforms such as Xbox. It could include two-way radios, video conferencing systems such as those offered by Polycom, or the Dlink eye2eye devices to name a few. It could also apply to two-way radios or walkie talkies. Of course it could also apply to communications by use of terminals connected with WAN or LAN computer networks, or communications over so-called Wireless LANS, or Wifi networks, or any other telecommunications means.

The foregoing detailed description of the present invention draws on references, examples, terminology and concepts from the art of GSM-based wireless common carrier telecommunications. But it will be appreciated that this manner of describing possible embodiments does not limit the scope of the present invention. The present invention may be implemented in any method of telecommunications in which information relevant to identifying the calling party can be displayed, played, or otherwise indicated for the end-user.

### REFERENCES

GSM-902, GSM-340, GSM-378, GSM-398, ITU 1214-1218, ITU 76x, GSM-1111, GSM-1114, GSM-318, GSM-382, GSM-80x, GSM-85X, GSM-222, GSM-43019

What is claimed is:

1. An apparatus for receiving, storing and presenting identifying information about unreturned calls for user interaction, the apparatus comprising:
A telecommunications end user device;
Reception and storage for information items identifying unreturned calls;
Output for presenting at least one of the items to an end user;
Interactive indicia for the end user to select and take action with respect to at least of those items.

2. The apparatus of claim 1, in which the action is returning the unreturned call.

3. The apparatus of claim 1, in which the action is deleting at least one of those items from that output.

4. A method for receiving, storing and presenting identifying information about unreturned calls for end-user interaction, the method comprising:
Receiving at least one identifying item of information about an unreturned call at an end-user telecommunications device;
Presenting said at least one item to an end-user;
Operating upon one of said at least one items in response to end-user interaction.

5. The method of claim 4, in which the operating comprises returning the unreturned call identified by that one item.

6. The method of claim 4, in which the operating comprises deleting that one item from the at least one items presented to the end-user for interaction.
